(19) United States
(12) Patent Application Publication
(10) Pub. No.: US 2020/0400233 A1
(43) Pub. Date: Dec. 24, 2020

(54) DUST PROOF SLEEVE

(71) Applicant: TRELLEBORG BOHEMIA, A.S., Hradec Kralove (CZ)

(72) Inventor: Jan Hrones, Hradec Králové (CZ)

(21) Appl. No.: 16/899,793

(22) Filed: Jun. 12, 2020

(30) Foreign Application Priority Data
Jun. 19, 2019 (CZ) PV 2019-388

(51) Int. Cl. F16J 3/04; B29C 45/14; B29C 35/02

(52) U.S. Cl. CPC F16J 3/04; B29C 35/02; B29C 45/14467

(57) ABSTRACT

The dust proof sleeve comprises a rubber tubular bellows part (1) with an opening at both ends for sliding onto an element fitted with the dust proof sleeve. The bellows part (1) comprises an accordion-shaped undulated wall with circumferential peaks (2) and circumferential valleys (3). The dust proof sleeve further comprises at least one reinforcement (4), which is arranged at least along a part of the circumference of the bellows part (1) and adjoins the circumferential shape of the bellows part (1). The at least one reinforcement (4) is at least partly integrated in the bellows part (1) by vulcanization. The invention further comprises a dust proof sleeve production mould and a dust proof sleeve production method.

### RELATED APPLICATION

This application claims the priority benefit of Czech Patent Application Ser. No. PV2019-388 entitled “Dust proof sleeve,” filed Jun. 19, 2019, the entire disclosure of which is incorporated herein by reference

### FIELD OF THE INVENTION

The invention relates to a dust proof sleeve comprising a rubber tubular bellows part with an opening at both ends for sliding onto an element protected by the dust proof sleeve, wherein the bellows part comprises an accordion-shaped undulated wall with circumferential peaks and circumferential valleys, and wherein the dust proof sleeve comprises at least one reinforcement, which is arranged at least along a part of the circumference of the bellows part and adjoins the circumferential shape of the bellows part. The invention further relates to a dust proof sleeve production mould and a production method of such a dust proof sleeve.

### PRIOR ART

Dust proof sleeves, also called bellows, are used for elastic sealing and coupling of various technical systems and parts they are mounted on.

Dust proof sleeves used as vacuum or overpressure ones are moulded as all-rubber products that are subsequently fitted with inner reinforcements (vacuum dust proof sleeve) or outer reinforcements (overpressure dust proof sleeve). The reinforcements have an annular shape (e.g., of a ring) and extend around the dust proof sleeve circumference. The reinforcements of an overpressure dust proof sleeve with a bellows part are located outside the dust proof sleeve in circumferential valleys of the accordion-shaped dust proof sleeve wall. The reinforcements of a vacuum dust proof sleeve with a bellows part are located inside the dust proof sleeve in the circumferential peaks of the accordion-shaped dust proof sleeve wall. The reinforcements are not fixed to the dust proof sleeve, but they are freely inserted in the valleys or peaks.

The design of existing dust proof sleeves with reinforcements shows a number of disadvantages. The completion of reinforcements outside or inside the dust proof sleeve represents a complex and costly production operation. Two reinforcement types, i.e., inner and outer, need to be available. Presence of inner reinforcements is difficult to check within the quality assurance of the finished dust proof sleeve. Reinforcements inside the dust proof sleeve prevent proper air flow inside the dust proof sleeve. Reinforcements are not fixed to the dust proof sleeve, and therefore they make rattling noise because the reinforcement does not exactly fit the valley or peak of the accordion-shaped dust proof sleeve wall, but there is a certain play between the reinforcement and dust proof sleeve wall.

It is an object of the invention to eliminate these disadvantages and to provide a dust proof sleeve with reinforcements offering high bearing capacity of the dust proof sleeve without the need of complex and costly installation of reinforcements on the finished rubber moulding of the dust proof sleeve. Another object is to provide a versatile dust proof sleeve for both the vacuum and overpressure applications and to save material costs of the reinforcements.

### SUMMARY OF THE INVENTION

The objective of the present application is achieved through a dust proof sleeve comprising a rubber tubular bellows part with an opening at both ends for sliding onto an element fitted with the dust proof sleeve, wherein the bellows part comprises an accordion-shaped undulated wall with circumferential peaks and circumferential valleys. Furthermore, the dust proof sleeve comprises at least one reinforcement, which is arranged at least along a part of the circumference of the bellows part and adjoins the circumferential shape of the bellows part. Moreover, the at least one reinforcement is at least partly integrated in the bellows part by vulcanization.

An advantage of the dust proof sleeve according to the invention is that integration of the reinforcement in the bellows part makes the same dust proof sleeve suitable for use as an overpressure and vacuum sleeve. Costly subsequent installation of reinforcements onto the rubber moulding is no longer necessary. Reinforcements integrated by vulcanization increase the bearing capacity of the dust proof sleeve several times, do not produce rattling sound and support better air flow inside the sleeve as reinforcements do not form obstacles inside the sleeve.

In a preferred embodiment of the dust proof sleeve, reinforcements are integrated by vulcanization in circumferential peaks and/or in circumferential valleys. This renders it possible to position reinforcements with respect to the intended application of the dust proof sleeve.

To further increase the bearing capacity of the dust proof sleeve, the dust proof sleeve reinforcements are preferably circumferential reinforcements.

Depending on the preferred embodiment of the dust proof sleeve, the reinforcements have a circular, rectangular or trapezoidal cross-section. The cross-section of reinforcements can be selected, e.g., with respect to the position of the reinforcement in the dust proof sleeve production mould. In addition, a profile of reinforcements without sharp edges increases the bearing capacity and service life of the dust proof sleeve, because contact of rubber with sharp edges of reinforcements damages the rubber.

The object of the present invention is also achieved through a dust proof sleeve production mould. The mould comprises a shell, which encompasses the cavity, and a core that is situated inside the cavity. Generally, the cavity is defined by the inner wall of the shell having, in at least a part of the cavity, a tubular bellows shape, which is undulated in an accordion style. Furthermore, between the core and the inner wall of the shell forming the cavity, a gap is arranged, defining the shape of the dust proof sleeve wall, the shell being divided into the bottom impression plate and top impression plate wherein the core and impression plates are separable from each other. Additionally, an injection channel is arranged in the shell to inject rubber into the mould, according to the invention the principle of which is that on the inner wall of the shell, at least one protrusion is arranged that is directed towards the cavity axis, extends along a part of the circumference of the inner wall of the shell and comprises a reinforcement insertion groove, the groove extending along the circumferential shape of the inner wall of the shell, and the open part of the groove being directed to the cavity axis.

An advantage of the dust proof sleeve production mould according to the invention is that the groove in the protrusion defines the position of the reinforcement that is inserted in the groove. The reinforcement is held in the groove, which prevents deformation of the reinforcement during vulcanization. The protrusion makes the integrated reinforcement in the finished dust proof sleeve by vulcanization visible in the place of the protrusion from the outside of the dust proof sleeve, which makes the presence of the reinforcement in the dust proof sleeve easy to check.

In a preferred embodiment of the dust proof sleeve production mould, protrusions with a groove are formed by the profile of the inner wall of the shell. An advantage of this embodiment is that protrusions are not a separate part attached to the mould, but are formed by the profile of the inner wall of the dust proof sleeve shell, which increases resistance of the protrusions during vulcanization when high pressures and forces are present in the place of injection of rubber into the mould, which may release a separately attached protrusion.

In a preferred embodiment of a dust proof sleeve production mould, the core comprises at least one brace projecting from the core towards the reinforcement inserted in the groove in the protrusion on the inner wall of the shell to support the reinforcement towards the core axis. The brace is used to additionally support the reinforcement. This allows you to use a reinforcement with low stiffness to reduce the material costs of the reinforcement.

The object of the present invention is also achieved through a dust proof sleeve production method wherein in the first step, the core is positioned in one of the impression plates, then the impression plates are applied onto each other to close the dust proof sleeve production mould. In the next step, the injection channel is used to inject pre-heated rubber mixture into the gap between the core and the inner wall of the shell, which is followed by vulcanization of rubber, and after the expiration of the vulcanization time, the mould is opened by mutual separation of the impression plates. Subsequently the core is separated from the remaining of the impression plates, and the dust proof sleeve is inflated to increase its volume so that it can be removed from the core, according to the invention the principle of which is that before the core is placed into one of the impression plates, at least one reinforcement is positioned onto the core, opposite the groove in the protrusion on the inner wall of the shell.

An advantage of the dust proof sleeve production method according to the invention is that after vulcanization of the dust proof sleeve, the product is completed, including the integrated reinforcements by vulcanization, and no subsequent additional installation of reinforcements is necessary.

In a preferred embodiment of the dust proof sleeve production method, a binding agent is applied on the surface of the reinforcements before the reinforcements are placed onto the core. This enhances resistance and service life of the dust proof sleeve and also improves the appearance of the dust proof sleeve with a reinforcement.

### BRIEF DESCRIPTION OF DRAWINGS

The dust proof sleeve, dust proof sleeve production mould and dust proof sleeve production method according to the invention will be described in more detail with the use of examples of particular embodiments, schematically shown in the attached drawings.

FIG. 1 shows a side view of the dust proof sleeve arrangement with a partial cross-section at the peaks of the accordion-shaped undulated dust proof sleeve wall.

FIG. 2 shows a 3D view of the dust proof sleeve arrangement of FIG. 1.

FIG. 3 shows a cross-section of the dust proof sleeve taken along its axis.

FIG. 4 shows a ground plan view of the arrangement of the bottom impression plate of the dust proof sleeve production mould.

FIG. 5 shows a 3D view of the arrangement of the bottom impression plate of the dust proof sleeve production mould of FIG. 4.

FIG. 6 shows a 3D view in partial cross-section of the arrangement of the dust proof sleeve production mould with the shell and core.

FIG. 7 shows a 3D view of the dust proof sleeve production mould core.

### EXAMPLES OF EMBODIMENTS OF THE INVENTION

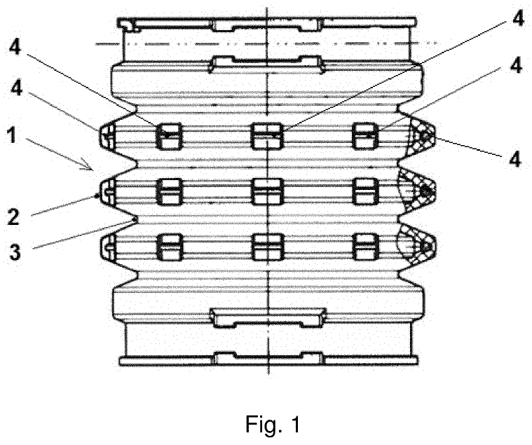

The dust proof sleeve of the embodiment of FIG. 1 comprises a rubber tubular bellows part 1. At both the ends, there is an opening making it possible to slide the dust proof sleeve onto the element fitted with the dust proof sleeve. The bellows part 1 comprises an accordion-shaped undulated wall with circumferential peaks 2 and circumferential valleys 3. FIG. 1 shows three circumferential peaks 2 and four circumferential valleys 3. The dust proof sleeve has three circumferential reinforcements 4 integrated by vulcanization, each positioned in one circumferential peak 2. Due to the production method, which will be described below, the circumferential peaks 2 have recesses in partial portions along the dust proof sleeve circumference. In the locations of the recesses, the reinforcement 4 is visible from the outside of the dust proof sleeve, outside the recesses, the reinforcement is completely integrated in the circumferential peaks 2 of the dust proof sleeve by vulcanization and is not visible. The reinforcement 4 of FIG. 1 has a trapezoidal profile with rounded edges.

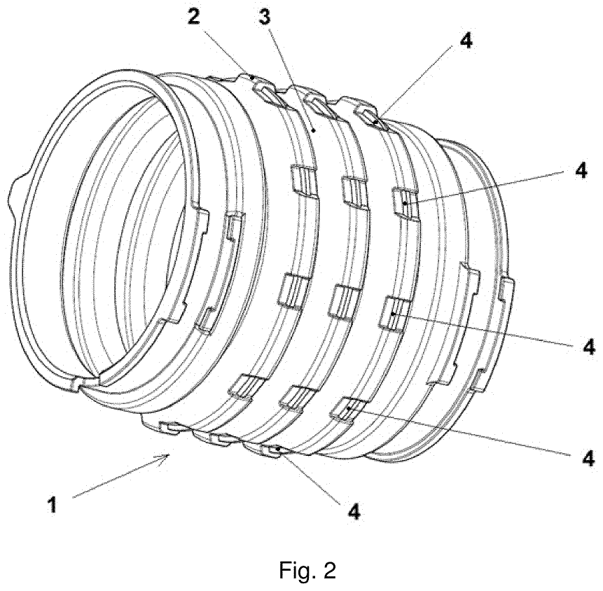

FIG. 2 shows a 3D view of the dust proof sleeve arrangement of FIG. 1 to provide a more illustrative view of the dust proof sleeve with integrated reinforcements 4 by vulcanization, which are visible in partial portions along the circumference of the dust proof sleeve.

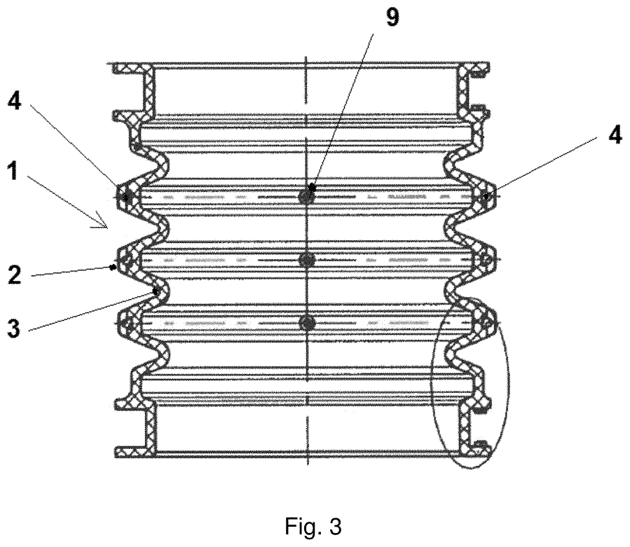

FIG. 3 shows a cross-section of the dust proof sleeve taken along its axis. The reinforcements 4 are arranged in the circumferential peaks 2 in the same way as in FIG. 1. Openings 9 are visible on the inner surface of the dust proof sleeve. The openings 9 are formed after the removal of the dust proof sleeve from the core 11 with auxiliary braces 14 wherein the core 11 with auxiliary braces 14 was used during the production of the dust proof sleeve of FIG. 3 for additional support of the reinforcements 4 towards the dust proof sleeve axis at selected points of the inner circumference of the reinforcements 4. The reason of the supporting is to prevent deformation of the reinforcements 4 during the injection of rubber into the mould, which occurs at high pressures and under the action of high forces. After the vulcanization of rubber, the dust proof sleeve is removed from the core 11 with the braces 14, and openings 9 will remain in the places of supporting of the reinforcements 4 on the inner surface of the dust proof sleeve. Supporting of reinforcements 4 is used when reinforcements 4 with low stiffness are used, e.g. made of plastic with a small cross-section. If a sufficiently stiff reinforcement 4 is used, e.g. made of metal or plastic with a sufficiently large cross-section, this supporting is not necessary and a core 11 without braces 14 is used for the production of the dust proof sleeve.

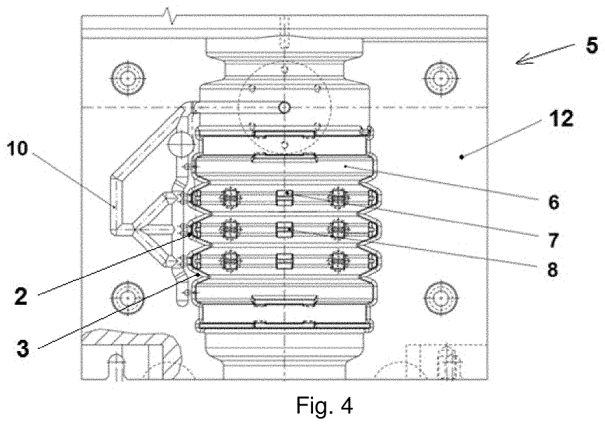

FIG. 4 shows a ground plan view of the arrangement of the bottom impression plate 12 of the dust proof sleeve production mould. The bottom impression plate 12 together with the top impression plate 13 form a shell 5 encompassing the cavity wherein the inner wall 6 of the shell 5 defining the cavity has a tubular bellows shape that is undulated in an accordion style. The shown bottom impression plate 12 of the mould part is used to produce a dust proof sleeve with three circumferential peaks 2 and four circumferential valleys 3. On the inner wall 6, multiple protrusions 7 are arranged in the circumferential peaks 2. The protrusions 7 are directed towards the cavity axis. A protrusion 7 comprises a groove 8 that extends along the circumferential shape of the inner wall 6 and the open part of the groove 8 is directed towards the cavity axis. FIG. 4 shows the injection channel 10 to supply rubber into the mould in the places of injection points.

A reinforcement 4 is inserted into a groove 8 inside the mould. The grooves 8 are used to ensure exact positioning of reinforcements in the mould 4 and they also prevent the reinforcements 4 from being displaced during the injection of rubber, which occurs at high pressures and exerts high forces onto the inside of the mould.

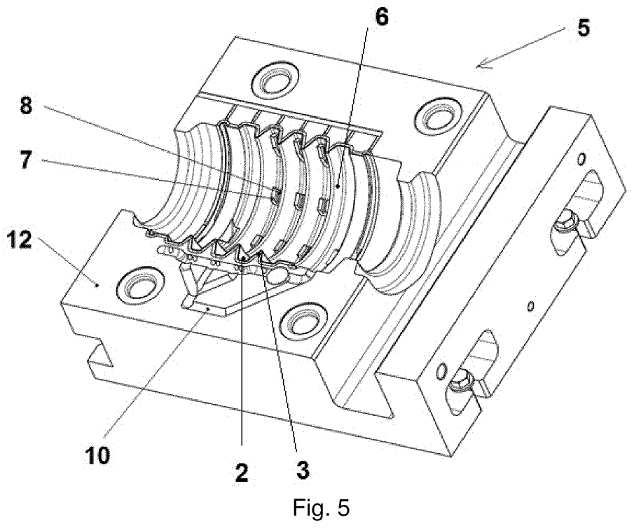

FIG. 5 shows a 3D view of the bottom impression plate 12 of FIG. 4 to provide a more illustrative view of the bottom impression plate 12.

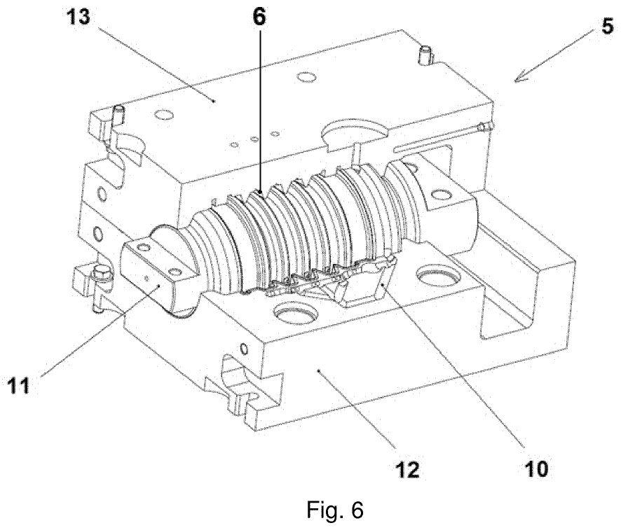

FIG. 6 represents a 3D view in a partial cross-section of the mould with the shell 5 and core 11. The shell 5 encompasses the cavity and the core 11 is situated inside the cavity. The cavity is defined by the inner wall 6 of the shell 5 having a tubular bellows shape, which is undulated in an accordion style. Between the core 11 and the inner wall 6 forming the cavity, a gap is arranged, defining the shape of the dust proof sleeve wall. The shell 5 is divided into the bottom impression plate 12 and the top impression plate 13. The core 11 and the impression plates 12, 13 are separable from each other and the shell 5 comprises an injection channel 10 to inject rubber into the mould.

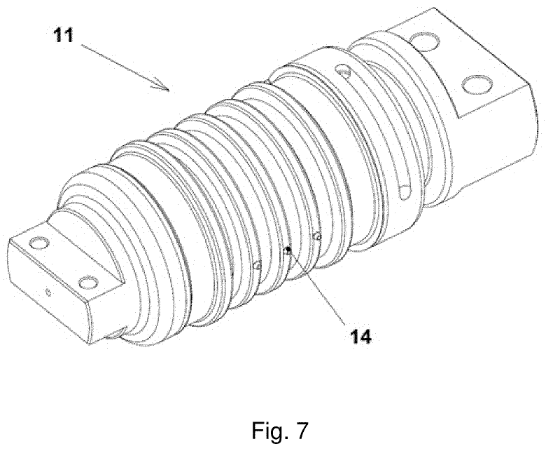

FIG. 7 shows a 3D view of the dust proof sleeve production mould core 11. On the core, braces 14 are arranged that are used to support the reinforcements 4 towards the axis of the core 11. A core 11 with braces 14 is used if reinforcements 4 with low stiffness are used to prevent them from being deformed during rubber injection occurring at high pressures.

The dust proof sleeve production method according to the present invention comprises application of a binding agent on the surface of the reinforcements 4 in the first step. The binding agent enhances resistance and service life of the dust proof sleeve. It also improves the appearance of a dust proof sleeve with a reinforcement in places where the reinforcement is visible from outside of the dust proof sleeve because thanks to the binding agent, rubber will also adhere to the part of the reinforcement not integrated by vulcanization inside the circumferential peak 2 in a thin layer. In the second step, reinforcements 4 are positioned on the core 11, opposite the grooves 8 on the inner wall 6 of the shell 5. In the third step, the core 11 is placed into the bottom impression plate 12 of the mould. In the fourth step, the bottom impression plate 12 with the core 11 is applied to the top impression plate 13. This will close the dust proof sleeve production mould. In the fifth step, the injection channel 10 is used to inject pre-heated rubber mixture into the mould into the gap between the core 11 and the inner wall 6 of the shell 5. In the sixth step, the rubber is vulcanized. After the expiration of the vulcanization time, in the seventh step, the mould is opened by removal of the bottom impression plate 12 with the core 11 from the top impression plate 13. In the eighth step, the core 11 is separated from the bottom impression plate 12. In the last, ninth step, the dust proof sleeve is inflated to be removed from the core 11. The inflation of the dust proof sleeve increases its volume, and therefore it is no longer firmly held by the core 11. For handling of the impression plates 12, 13, the impression plates 12, 13 are attached to moving stages, which are part of the moulding machine (not shown in the figures). For handling of the core 11, the core 11 is attached to an ejector, which is part of the moulding machine (not shown in the figures). To inflate the dust proof sleeve to remove it from the core 11, an inflating fixture is used (not shown in the figures), which blows air between the dust proof sleeve and core. This will temporarily increase the volume of the dust proof sleeve, which can be then removed from the core 11.

### List of Reference Numbers

1 bellows part
2 circumferential peak
3 circumferential valley
4 reinforcement
5 shell
6 inner wall of the shell
7 protrusion
8 groove
9 opening
10 injection channel
11 core
12 bottom impression plate
13 top impression plate
14 brace

1. A dust proof sleeve comprising:
(a) a rubber tubular bellows part comprising a circumferential shape with a circumference and an opening at both ends for sliding onto an element fitted with the dust proof sleeve, wherein the bellows part comprises an accordion-shaped undulated wall with circumferential peaks and circumferential valleys; and
(b) at least one reinforcement arranged at least along a part of the circumference of the bellows part and adjoining the circumferential shape of the bellows part, wherein the at least one reinforcement is at least partly integrated in the bellows part by vulcanization.

2. The dust proof sleeve according to claim 1, wherein the at least one reinforcement is integrated in the circumferential peaks and/or the circumferential valleys by vulcanization.

3. The dust proof sleeve according to claim 1, wherein the at least one reinforcement is a circumferential reinforcement.

4. The dust proof sleeve according to claim 1, wherein the at least one reinforcement has a circular, rectangular or trapezoidal cross-section.

5. The dust proof sleeve according to claim 1, wherein the at least one reinforcement is made of a solid material.

6. A mould for the production of the dust proof sleeve according to claim 1, wherein the mould comprises:
(a) a shell that encompasses a cavity having a cavity axis;
(b) a core that is situated inside the cavity, wherein the cavity is defined by an inner wall of the shell having, in at least a part of the cavity, a tubular bellows shape that is undulated in an accordion style;
(c) an injection channel being arranged in the shell to inject rubber into the mould,
wherein a gap is arranged between the core and the inner wall forming the cavity, the gap defining the shape of the dust proof sleeve wall,
wherein the shell is divided into a bottom impression plate and a top impression plate,
wherein the core, the bottom impression plate, and the top impression plate are separable from each other,
wherein, on the inner wall of the shell, at least one protrusion is arranged that is directed towards the cavity axis, extends along a part of an inner wall circumference of the inner wall, and comprises a reinforcement insertion groove,
wherein the groove extends along the inner wall and comprises an open groove part that is directed to the cavity axis.

7. The mould according to claim 6, wherein the at least one protrusion with the groove are formed by a profile of the inner wall of the shell.

8. The mould according to claim 6, wherein the core comprises a core axis and at least one brace projecting from the core towards the least one reinforcement inserted in the groove to support the at least one reinforcement towards the core axis.

9. A production method of the dust proof sleeve in a mould according to claim 6, the method comprising:
(a) positioning the core in the bottom impression plate or the top impression plate;
(b) applying the bottom impression plate and the top impression plate onto each other to thereby close the mould;
(c) injecting via the injection channel a pre-heated rubber mixture into the gap between the core and the inner wall of the shell;
(d) vulcanizing the rubber mixture;
(e) after expiration of the vulcanizing, opening the mould by mutual separation of the bottom impression plate and the top impression plate, thereby causing the core to separate from the bottom impression plate and the top impression plate; and
(f) inflating the dust proof sleeve to thereby increase its volume so that the dust proof sleeve can be removed from the core,
wherein, before the positioning of the core, the at least one reinforcement is positioned onto the core, opposite the groove in the protrusion on the inner wall of the shell.

10. The production method according to claim 9, wherein, before the at least one reinforcements is placed onto the core, a binding agent is applied on the surface of the at least one reinforcement.
